(19) United States
(12) Patent Application Publication
(10) Pub. No.: US 2026/0295853 A1
(43) Pub. Date: Oct. 1, 2026

(54) APPARATUS AND METHOD FOR RACK MODELING

(71) Applicant: ELECTRONICS AND TELECOMMUNICATIONS RESEARCH INSTITUTE, Daejeon (KR)

(72) Inventors: Su Yong AN, Daejeon (KR); Laekyoung LEE, Daegu (KR)

(73) Assignee: ELECTRONICS AND TELECOMMUNICATIONS RESEARCH INSTITUTE, Daejeon (KR)

(21) Appl. No.: 19/578,854

(22) Filed: Mar. 25, 2026

(30) Foreign Application Priority Data
Mar. 27, 2025 (KR) 10-2025-0039842

(51) Int. Cl. B25J 9/16; G06V 10/762

(52) U.S. Cl. CPC B25J 9/1697; G06V 10/762

(57) ABSTRACT

A rack modeling apparatus includes: a buffer; a memory; a communication module for communicating with a robot that is equipped with a 2D LiDAR and configured to move inside a logistics factory provided with a plurality of racks; and a processor connected to the buffer, the memory, and the communication module. The processor repeatedly performs, at a predetermined set period, an operation including: acquiring point cloud data through the communication module; detecting a rack model based on the acquired point cloud data; storing the detected rack model in the buffer when the detected rack model is not stored in the buffer; assigning a preset score to the detected rack model when the detected rack model is already stored in the buffer; and storing, in the memory, a rack model having a score equal to or greater than a predetermined reference score among the rack models stored in the buffer.

### TECHNICAL FIELD

The present disclosure relates to a rack modeling apparatus and method for modeling racks provided inside a logistics factory.

### BACKGROUND

Recently, autonomous robots are being actively used in logistics factories. An autonomous robot performs logistics tasks while traveling around racks provided in a logistics factory, and for the autonomous robot to perform stable and efficient logistics tasks, it is essential to accurately recognize the structure of the racks within the travel environment and generate an optimal path based thereon.

Conventionally, a method of modeling the entire structure of racks in a logistics environment by using expensive sensors such as 3D LiDAR has been mainly used. Although 3D LiDAR has the advantage of providing high-resolution spatial information, its high cost imposes a limitation on its application in large-scale logistics environments. On the other hand, 2D LiDAR has the advantage of being relatively inexpensive and simple to use, but since the 2D LiDAR only provides cross-sectional information on a horizontal or vertical plane, it has limitations in completely detecting structures like racks or grasping the entire structure of the travel environment.

The background art of the present disclosure is disclosed in Korean Patent Registration Publication No. 10-2403460 (Published on May 25, 2022).

### SUMMARY

Embodiments provide a rack modeling apparatus and method capable of modeling racks provided inside a logistics factory by using point cloud data collected through a robot equipped with a 2D LiDAR.

In accordance with a first aspect of the present disclosure, there is provided a rack modeling apparatus, including: a buffer; a memory; a communication module configured to communicate with a robot that is equipped with a 2D LiDAR and configured to move inside a logistics factory provided with a plurality of racks; and a processor connected to the buffer, the memory, and the communication module, wherein the processor is configured to repeatedly perform, at a predetermined set period, an operation including: acquiring point cloud data through the communication module; detecting a rack model based on the acquired point cloud data; storing the detected rack model in the buffer when the detected rack model is not stored in the buffer; assigning a preset score to the detected rack model when the detected rack model is already stored in the buffer; and storing, in the memory, a rack model having a score equal to or greater than a predetermined reference score among the rack models stored in the buffer.

Further, the processor may be configured to: detect a rack frame model from the point cloud data; identify the rack frame model satisfying a predetermined rack size condition; connect the identified rack frame model and a target for each of the detected rack frame models; and identify, as the rack model, a rectangular structure having the rack frame models as corners.

Further, the rack size condition may be satisfied when a distance from the target is equal to a first reference distance or a second reference distance, and the first reference distance may be determined based on a predetermined rack width, and the second reference distance may be determined based on a predetermined rack length.

Further, the processor may be configured to: generate a plurality of clusters by clustering points included in the point cloud data through a Euclidean clustering algorithm, and identify, as the rack frame model, the cluster satisfying a predetermined frame length condition from among the plurality of clusters.

Further, the frame length condition may be satisfied when a distance between a center point and a farthest point from the center point is equal to a third reference distance, and the third reference distance may be determined based on a predetermined rack frame height.

Further, the processor may be configured to: calculate a median of angles of the rack models stored in the memory; and adjust positions of the rack models stored in the memory based on the median.

Further, the processor may be configured to: identify a rack model pair satisfying a predetermined model pair condition among the rack models stored in the memory; identify a reference rack model pair among the identified rack model pairs, the reference rack model pair being a rack model pair closest to the robot; generate a reference rack model based on the reference rack model pair; and adjust a position of the rack model stored in the memory based on a position of the reference rack model.

Further, the model pair condition may be that a center distance between rack models is within a predetermined reference range.

Further, the processor may be configured to: generate the reference rack model based on predetermined rack layout information.

Further, the processor may be configured to: identify a rack model pair satisfying a predetermined model pair condition among the rack models stored in the memory; generate a virtual rack model based on the rack model pair; and store the virtual rack model in the memory.

Further, the processor may be configured to: generate a virtual rack model at a position separated to the left from a center point of a rack model located on a left side of the rack model pair by a first predetermined set distance; generate a virtual rack model at a position separated to the right from a center point of a rack model located on a right side of the rack model pair by the first predetermined set distance; generate a virtual rack model at positions separated upward and downward from the center point of the rack model located on the left side of the rack model pair by a second predetermined set distance; and generate a virtual rack model at positions separated upward and downward from the center point of the rack model located on the right side of the rack model pair by the second predetermined set distance.

In accordance with a second aspect of the present disclosure, there is provided a rack modeling method, including: acquiring, by a processor, point cloud data from a robot equipped with a 2D LiDAR and configured to move inside a logistics factory provided with a plurality of racks; detecting, by the processor, a rack model based on the acquired point cloud data; storing, by the processor, the detected rack model in a buffer when the detected rack model is not stored in the buffer; assigning, by the processor, a predetermined score to the detected rack model when the detected rack model is already stored in the buffer; storing, by the processor, a rack model in a memory from among the rack models stored in the buffer when the predetermined score is equal to or greater than a predetermined reference score; and repeatedly performing, by the processor, at a predetermined set period, the acquiring, the detecting, the storing in the buffer, the assigning, and the storing in the memory.

Further, the detecting the rack model may include: detecting, by the processor, a rack frame model from the point cloud data; detecting, by the processor, a rack frame model satisfying a predetermined rack size condition, and connecting the detected rack frame model and a target for each of the detected rack frame models; and identifying, by the processor, a rectangular structure having the rack frame models as corners as the rack model.

Further, the rack size condition may be satisfied when a distance from the target is equal to a first reference distance or a second reference distance, and the first reference distance may be determined based on a predetermined rack width, and the second reference distance may be determined based on a predetermined rack length.

Further, the detecting the rack model may include: generating, by the processor, a plurality of clusters by clustering points included in the point cloud data through a Euclidean clustering algorithm; and identifying, by the processor, a cluster satisfying a predetermined frame length condition among the plurality of clusters as a rack frame model.

Further, the frame length condition may include a distance between a center point and a farthest point from the center point matching a third reference distance, and the third reference distance is determined based on a predetermined rack frame height.

Further, the rack modeling method may further include, after the storing in the memory: calculating, by the processor, a median of angles of the rack models stored in the memory; and adjusting, by the processor, positions of the rack models stored in the memory according to the median value.

Further, the rack modeling method may further include: identifying, by the processor, a rack model pair satisfying a predetermined model pair condition among the rack models stored in the memory; identifying, by the processor, a reference rack model pair among the identified rack model pairs, the reference rack model pair being a rack model pair closest to the robot; generating, by the processor, a reference rack model based on the reference rack model pair; and adjusting, by the processor, a position of the rack model stored in the memory based on a position of the reference rack model.

Further, the model pair condition may be that a center distance between rack models is within a predetermined reference range.

Further, the generating the reference rack model may include generating the reference rack model based on predetermined rack layout information.

According to an aspect of the present disclosure, the present disclosure may enable an autonomous robot to travel along a stable and optimized path within a logistics factory by modeling racks provided inside the logistics factory by using point cloud data collected through a robot equipped with a 2D LiDAR.

### BRIEF DESCRIPTION OF THE DRAWINGS

FIG. 1 is a block diagram illustrating a rack modeling apparatus according to an embodiment of the present disclosure.

FIG. 2 is an exemplary diagram illustrating an arrangement of racks in a logistics factory.

FIGS. 3A and 3B are exemplary diagrams illustrating a process of detecting a rack frame model.

FIG. 4 is an exemplary diagram illustrating a structure of a rack.

FIG. 5 is an exemplary diagram illustrating a process of generating a rack model.

FIGS. 6 to 8 are exemplary diagrams illustrating a process of correcting the position of a rack model.

FIGS. 9A, 9B, 10A and 10B are exemplary diagrams illustrating a process of generating a virtual rack model.

FIG. 11 is a flowchart illustrating a rack modeling method according to the embodiment of the present disclosure.

FIG. 12 is a flowchart illustrating a process of detecting the rack model.

FIG. 13 is a flowchart illustrating a process of detecting the rack frame model.

FIG. 14 is a flowchart illustrating a process of correcting the position of the rack model.

FIG. 15 is a flowchart illustrating another process of correcting the position of the rack model.

FIG. 16 is a flowchart illustrating a process of generating the virtual rack model.

### DETAILED DESCRIPTION

Hereinafter, embodiments of a rack modeling apparatus and method according to the present disclosure will be described.

In this process, the thickness of lines or the size of components shown in the drawings may be exaggerated for clarity and convenience of description. Furthermore, the terms described below are terms defined in consideration of functions in the present disclosure, and they may vary according to the intention or custom of a user or operator. Therefore, the definition of these terms should be made based on the content throughout this specification.

Hereinafter, embodiments of the present disclosure will be described in detail with reference to the accompanying drawings so that those skilled in the art to which the present disclosure pertains may easily carry out the embodiments. However, the present disclosure may be embodied in many different forms and is not limited to the embodiments described herein. And, in the drawings, parts unrelated to the description are omitted to clearly describe the present disclosure, and similar reference numerals are attached to similar parts throughout the specification.

Throughout the specification, when a part is said to "include" a certain component, it means that the part may include other components, not excluding them, unless otherwise stated.

The implementations described in this specification may be implemented as, for example, a method or process, an apparatus, a software program, a data stream, or a signal. Even if discussed only in the context of a single form of implementation (e.g., discussed only as a method), the implementation of the discussed features may also be implemented in other forms (e.g., an apparatus or a program). An apparatus may be implemented with appropriate hardware, software, and firmware, etc. A method may be implemented in an apparatus such as a processor, which generally refers to a processing device including, for example, a computer, a microprocessor, an integrated circuit, or a programmable logic device, etc.

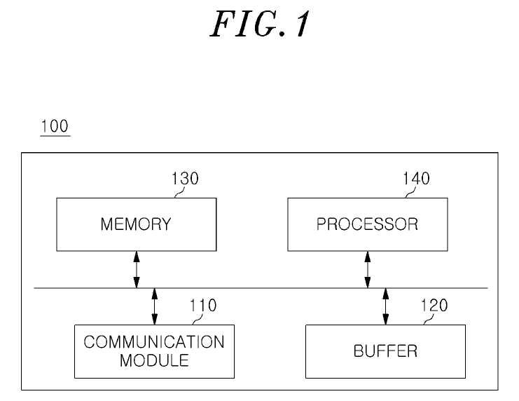

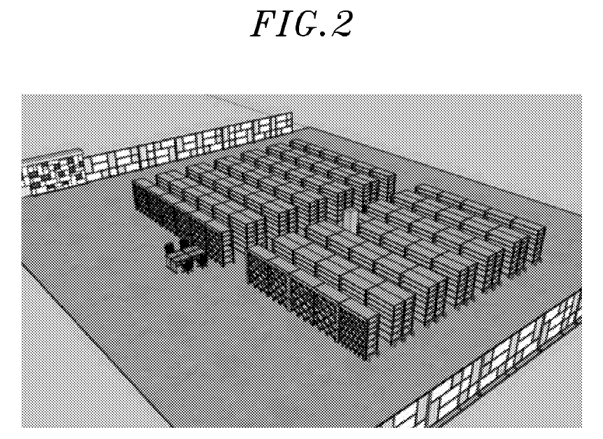

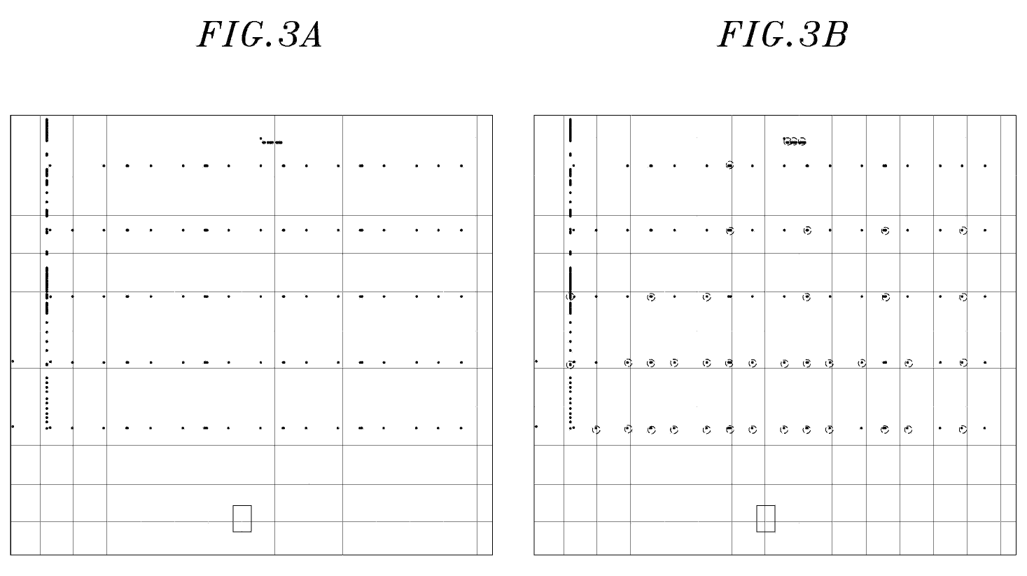

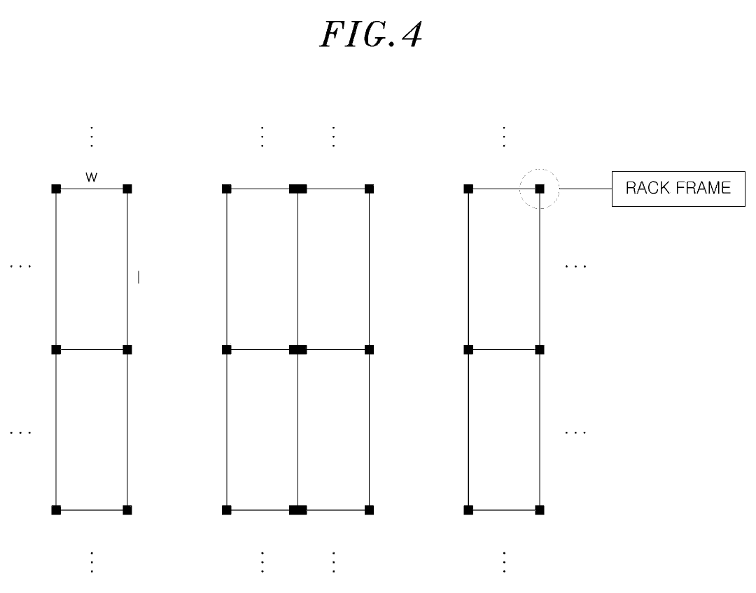

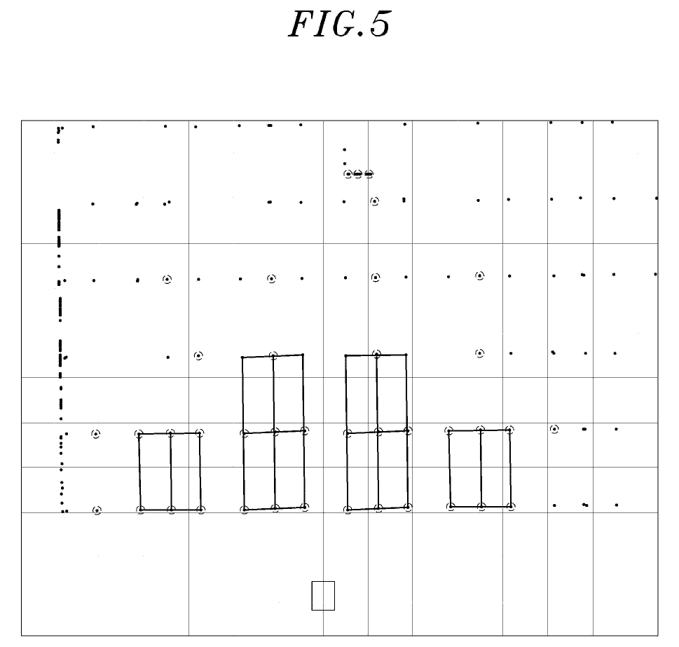

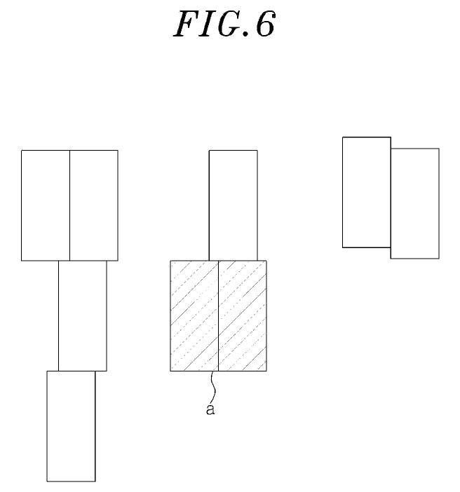

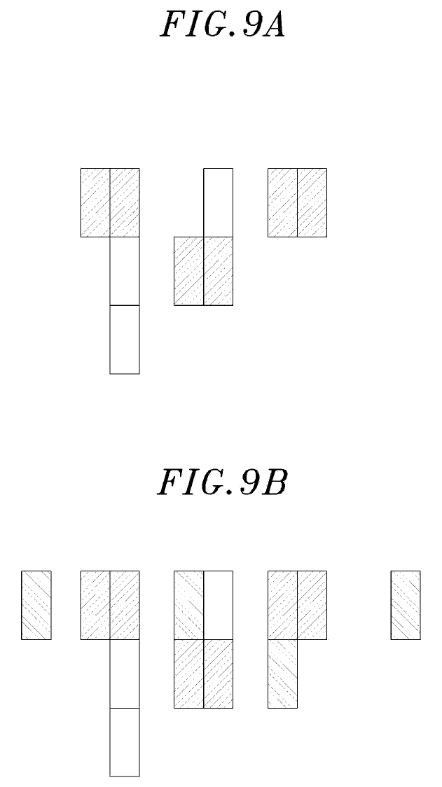

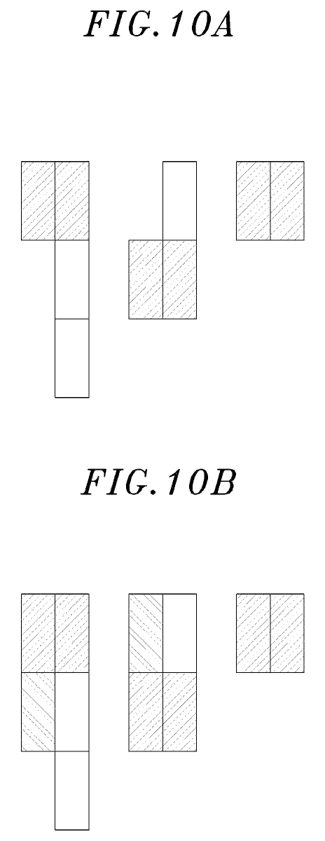

FIG. 1 is a block diagram illustrating a rack modeling apparatus according to an embodiment of the present disclosure, FIG. 2 is an exemplary diagram illustrating an arrangement of racks in a logistics factory, FIGS. 3A and 3B are exemplary diagrams illustrating a process of detecting a rack frame model, FIG. 4 is an exemplary diagram illustrating a structure of a rack, FIG. 5 is an exemplary diagram illustrating a process of generating a rack model, FIGS. 6 to 8 are exemplary diagrams illustrating a process of correcting the position of a rack model, and FIGS. 9A to 10B are exemplary diagrams illustrating a process of generating a virtual rack model.

Referring to FIG. 1, a rack modeling apparatus 100 according to an embodiment of the present disclosure may include a communication module 110, a buffer 120, a memory 130, and a processor 140. The rack modeling apparatus 100 according to the embodiment of the present disclosure may further include various components in addition to the components shown in FIG. 1.

The communication module 110 may perform communication with an external device. The communication module 110 may perform communication with various types of external devices according to various types of communication methods. The communication module 110 may perform communication with a robot and may acquire point cloud data regarding the inside of a logistics factory from the robot. The robot may be an autonomous robot programmed to move inside the logistics factory. The robot may be equipped with a 2D LiDAR. The robot may generate point cloud data regarding the inside of the logistics factory through the 2D LiDAR while traveling inside the logistics factory. FIG. 2 illustrates an arrangement of racks in a logistics factory.

The buffer 120 may be a device for temporarily storing data. A rack model may be stored (registered) in the buffer 120. The rack model may refer to the result of modeling a rack. In the present embodiment, storing a rack model in the buffer 120 may mean that identification information, position information, and size information regarding the rack model are stored in the buffer 120.

The memory 130 may be a device for permanently storing a portion of the data stored in the buffer 120. A rack model may be stored in the memory 130. In the present embodiment, storing a rack model in the memory 130 may mean that identification information, position information, and size information regarding the rack model are stored in the memory 130.

The memory 130 may store at least one instruction that is executed by the processor 140 in the process of modeling the rack. The memory 130 may store basic data required for the processor 140 to model the rack, or may store data generated by the processor 140 in the process of modeling the rack, and the processor 140 may access the data stored in the memory 130 to perform the operation of modeling the rack. The memory 130 may be implemented as a computer-readable recording medium to operate so as to be accessible by the processor 140. Specifically, the memory 130 may be implemented as an optical data storage device such as a hard drive, a magnetic tape, a memory card, a read-only memory (ROM), a random-access memory (RAM), a digital video disc (DVD), or an optical disc.

The processor 140 is an entity performing the operation of modeling the rack, and may be implemented as an application specific integrated circuit (ASIC), a digital signal processor (DSP), programmable logic devices (PLD), field programmable gate arrays (FPGAs), a central processing unit (CPU), microcontrollers, and/or microprocessors, and may drive an operating system or an application and control a plurality of hardware or software components. The processor 140 may be programmed to execute at least one command stored in the memory 130, and to store the execution result data in the memory 130.

The processor 140 may repeatedly perform, at a predefined set period, an operation including: acquiring point cloud data through the communication module 110; detecting a rack model based on the acquired point cloud data; if the detected rack model is not stored (registered) in the buffer 120, storing the detected rack model in the buffer 120; if the detected rack model is already stored in the buffer 120, assigning a preset score to the corresponding model (a rack model stored in the buffer 120 corresponding to the detected rack model); identifying a rack model among the rack models stored in the buffer 120 whose score is equal to or greater than a predefined reference score; and storing (registering) the identified rack model in the memory 130. The present embodiment may perform modeling of racks in a logistics factory by detecting a rack model using point cloud data, identifying a consecutively detected rack model (a rack model detected multiple times), and storing the identified rack model in the memory 130. A rack which does not actually exist may be modeled due to noise, and therefore, the present embodiment may temporarily store a detected rack model in the buffer 120 for verification, and store it in the memory 130 upon completion of the verification.

The processor 140 may calculate a center distance to the detected rack model for each of the rack models stored in the buffer 120, and if a rack model with a calculated center distance less than or equal to a preset value exists in the buffer 120, the processor may determine that the detected rack model is already stored in the buffer 120, and if a rack model with a calculated center distance less than or equal to a preset value does not exist in the buffer 120, the processor may determine that the detected rack model is not stored in the buffer 120. That is, the processor 140 may determine the identity of a rack model based on the center distance (distance between centers).

The processor 140 may also decrease the score of all rack models stored in the buffer 120 by a preset value at a preset period. Furthermore, the processor 140 may remove a rack model whose score is less than or equal to a preset value from the buffer 120 at a preset period. The present embodiment may prevent a rack model that has not been consecutively detected from being registered in the memory 130 by decreasing the score of all rack models stored in the buffer 120 by a preset value at a preset period and simultaneously removing a rack model whose score is less than or equal to a preset value from the buffer 120.

The processor 140 may detect a rack frame model from the point cloud data. The rack frame model may refer to the result of modeling a rack frame. The rack frame may refer to the supporting structure (pillar) of a rack. The rack frame may be installed at each corner of the rack. The processor 140 may cluster the points included in the point cloud data through a Euclidean clustering algorithm to generate a plurality of clusters, and identify a cluster satisfying a predefined condition (frame length condition) among the generated plurality of clusters as a rack frame model. The frame length condition may be that the distance between a center point of the cluster and the farthest point from the center point matches a third reference distance. The third reference distance may be determined according to a height of a rack frame. In one embodiment, the third reference distance may correspond to a value obtained by dividing the height of the rack frame by 2. The height of the rack frame may be predefined. The present embodiment may determine whether a cluster corresponds to a rack frame based on length. FIG. 3A illustrates point cloud data, and FIG. 3B illustrates a result of detecting a rack frame model.

The processor 140 may identify a rack frame model that satisfies a predefined condition (hereinafter referred to as a rack size condition), may perform, for each of the detected rack frame models, an operation of connecting the identified rack frame model with an object, and may identify a set of rack frame models having a connection relationship as a rack model. The rack size condition may be that a distance to a target matches a first reference distance or a second reference distance. The first reference distance may be determined according to a width of a rack, and the second reference distance may be determined according to a length of a rack. The width and length of the rack may be predefined in advance. That is, for each of the detected rack frame models, the processor 140 may perform an operation of connecting the object with a rack frame model located at a position spaced apart from the object by the width (horizontal length) or the length (vertical length) of the rack, and may identify, as a rack model, a quadrangular structure having the rack frame models as corners. In the present embodiment, it is assumed that the rack is standardized to have a rectangular structure with a fixed size. FIG. 4 illustrates the structure of a rack. FIG. 5 illustrates a result of detecting a rack model.

The processor 140 may determine whether a rack model with a score equal to or greater than a reference score is already stored in the memory 130, and if the corresponding rack model is not stored in the memory 130, the processor 140 may store the corresponding rack model in the memory 130. If the rack model with a score equal to or greater than the reference score is already stored in the memory 130, the processor 140 may update the rack model previously stored in the memory 130 with the rack model with a score equal to or greater than the reference score. The processor 140 may calculate a center distance to the rack model with a score equal to or greater than the reference score for each of the rack models stored in the memory 130, and if a rack model with a calculated center distance less than or equal to a predefined value exists in the memory 130, the processor may determine that the rack model with a score equal to or greater than the reference score is already stored in the memory 130, and if a rack model with a calculated center distance less than or equal to a predefined value does not exist in the memory 130, the processor may determine that the rack model with a score equal to or greater than the reference score is not stored in the memory 130. That is, the processor 140 may determine the identity of a rack model based on the center distance (distance between centers).

The processor 140 may calculate a median of the angles of the rack models stored in the memory 130 (an angle calculated based on a predefined reference line, which is the angle at which the rack model is tilted when viewed from directly above) and correct the positions of the rack models stored in the memory 130 according to the calculated median value. The processor 140 may correct the angle of each of the rack models stored in the memory 130 so that the angle becomes the median value. Generally, racks in a logistics factory are arranged in the same direction. Therefore, the present embodiment may calculate the global orientation of the rack models and correct (align) the positions of the rack models stored in the memory 130 according to the calculated global orientation.

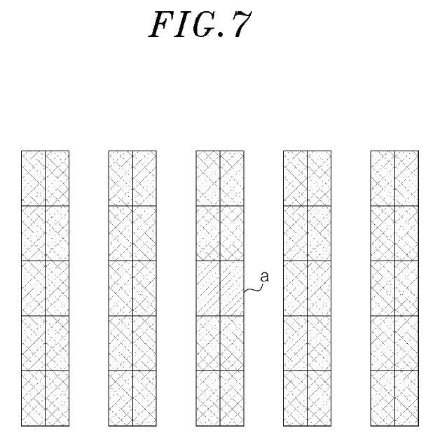

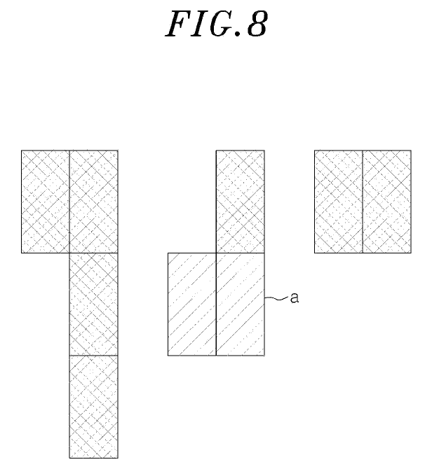

The processor 140 may identify a rack model pair satisfying a predefined condition (hereinafter, model pair condition) among the rack models stored in the memory 130, identify a reference rack model pair, which is the rack model pair currently closest to the robot, among the identified rack model pairs, generate a reference rack model based on the reference rack model pair, and correct the position information of the rack models stored in the memory 130 according to the position information of the reference rack model. The model pair condition may be that the center distance between rack models is within a predefined reference range. The reference range may be set based on a width of a rack. The present embodiment may reconfigure the rack models stored in the memory 130 to be aligned as a whole through the process of correcting the positions of the rack models stored in the memory 130 according to the position information of the reference rack model. FIG. 6 illustrates rack models stored in the memory 130, FIG. 7 illustrates a result of generating a reference rack model, and FIG. 8 illustrates a result of correcting the rack models stored in the memory 130 using the reference rack model. In FIGS. 6 to 8, 'a' indicates a reference rack model pair.

The processor 140 may identify rack models adjacent to each other as a rack model pair. The processor 140 may generate the reference rack model according to predefined rack layout information. The rack layout information may include various types of information related to the layout of racks, such as the total number of racks arranged in the logistics factory, the vertical distance between racks, the horizontal distance between racks, the number of rack rows (rows composed of racks) arranged in the logistics factory, and the distance between rack rows. The processor 140 may generate a virtual rack model (i.e., the reference rack model) based on the reference rack model pair by referring to the rack layout information, and correct the positions of the rack models stored in the memory 130 based on the generated virtual rack model. The processor 140 may perform, for each of the rack models stored in the memory 130, an operation of correcting the position so as to match the position of a corresponding reference rack model.

The processor 140 may identify a rack model pair that satisfies the model pair condition among the rack models stored in the memory 130, generate a virtual rack model based on the identified rack model pair, and store the generated virtual rack model in the memory 130. The present embodiment may predict the position of an undetected rack model using already detected rack models and reflect the prediction result in the rack modeling result.

The processor 140 may generate a virtual rack model at a position separated to the left from the center point of the rack model located on the left side of the rack model pair by a first predetermined set distance. The processor 140 may generate a virtual rack model at a position separated to the right from the center point of the rack model located on the right side of the rack model pair by the first set distance. The processor 140 may generate a virtual rack model at positions separated upward and downward from the center point of the rack model located on the left side of the rack model pair by a second predetermined set distance. The processor 140 may generate a virtual rack model at positions separated upward and downward from the center point of the rack model located on the right side of the rack model pair by the second set distance. In various embodiments, when generating a virtual rack model at positions separated upward and downward from the center point of a rack model by the second set distance, the processor 140 may generate the virtual rack model only if a rack model pair is completed by the generation of the virtual rack model. That is, the processor 140 may generate a virtual rack model at a desired position only when a rack model already exists immediately adjacent to that position. FIG. 9A illustrates rack models stored in the memory 130, and FIG. 9B illustrates a result of generating virtual rack models to the left and right of a rack model pair. FIG. 10A illustrates rack models stored in the memory 130, and FIG. 10B illustrates a result of generating virtual rack models on upper and lower sides of the rack model pair.

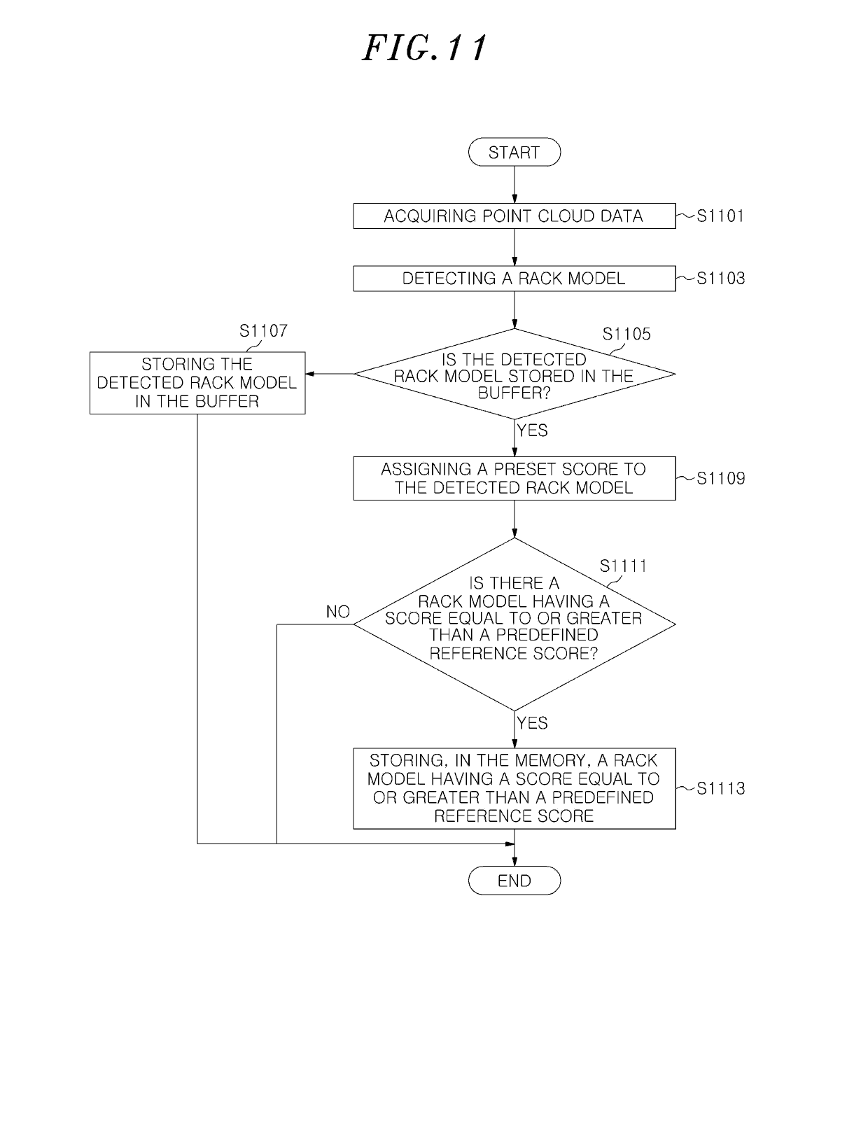

FIG. 11 is a flowchart illustrating a rack modeling method according to the embodiment of the present disclosure.

Hereinafter, a rack modeling method according to the embodiment of the present disclosure will be described with reference to FIG. 11. Some of the operations to be described below may be performed in a different order from the order described below or may be omitted. The process of FIG. 11 to be described below may be repeatedly performed at a predefined set period.

First, the processor 140 may acquire point cloud data (S1101). In operation S1101, the processor 140 may acquire the point cloud data from the robot through the communication module 110.

Next, the processor 140 may detect a rack model based on the point cloud data (S1103). A detailed description of the method for detecting the rack model will be described below.

Next, the processor 140 may determine whether the detected rack model is stored in the buffer 120 (S1105). In operation S1105, the processor 140 may calculate a center distance to the detected rack model for each of the rack models stored in the buffer 120, and if a rack model with a calculated center distance less than or equal to a predefined value exists in the buffer 120, it may determine that the detected rack model is stored in the buffer 120.

If the detected rack model is not stored in the buffer 120, the processor 140 may store the corresponding rack model in the buffer 120 (S1107), and may terminate the process.

On the other hand, if the detected rack model is already stored in the buffer 120, the processor 140 may assign a preset score to the corresponding rack model (S1109).

Next, the processor 140 may determine whether a rack model whose score is equal to or greater than a predetermined reference score exists among the rack models stored in the buffer 120 (S1111).

If a rack model whose score is equal to or greater than the reference score does not exist among the rack models stored in the buffer 120, the processor 140 may terminate the corresponding process.

On the other hand, if a rack model whose score is equal to or greater than the reference score exists among the rack models stored in the buffer 120, the processor 140 may store the rack model whose score is equal to or greater than the reference score in the memory 130 (S1113).

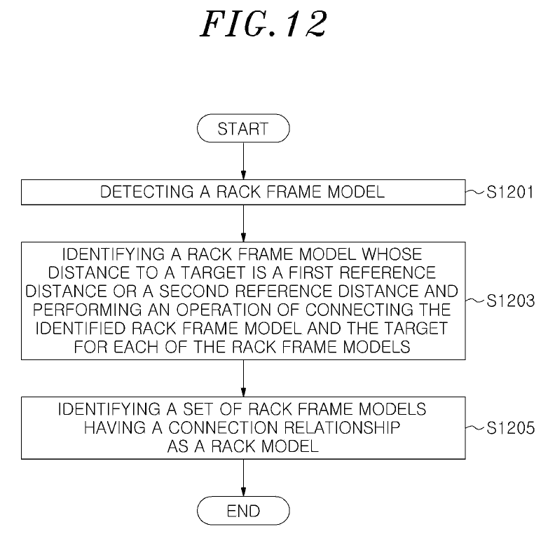

FIG. 12 is a flowchart illustrating a process of detecting a rack model.

Hereinafter, the process of detecting a rack model will be described with reference to FIG. 12. Some of the operations to be described below may be performed in a different order from the order described below or may be omitted.

First, the processor 140 may detect a rack frame model from the point cloud data (S1201).

Next, the processor 140 may identify a rack frame model whose distance to a target is a first reference distance or a second reference distance, and perform an operation of connecting the identified rack frame model and the target with a straight line for each of the rack frame models (S1203). The first reference distance may be determined according to a width of a rack, and the second reference distance may be determined according to a length of a rack.

Next, the processor 140 may identify a set of rack frame models having a connection relationship as a rack model (S1205). In operation S1205, the processor 140 may identify a rectangular structure having the rack frame models as corners as the rack model.

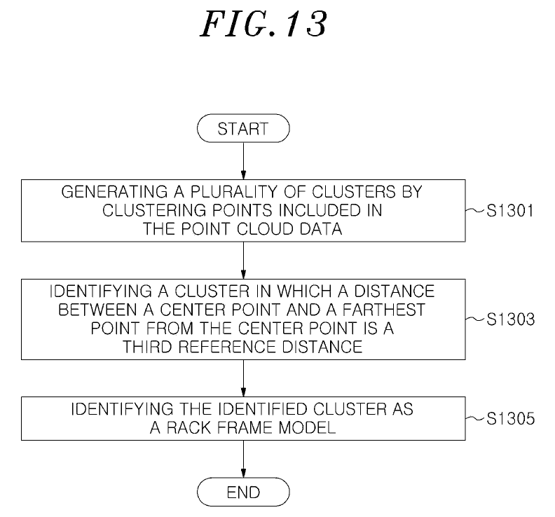

FIG. 13 is a flowchart illustrating a process of detecting a rack frame model.

Hereinafter, the process of detecting a rack frame model will be described with reference to FIG. 13. Some of the operations to be described below may be performed in a different order from the order described below or may be omitted.

First, the processor 140 may cluster the points included in the point cloud data through the Euclidean clustering algorithm to generate a plurality of clusters (S1301).

Next, the processor 140 may identify a cluster among the plurality of clusters in which the distance between a center point and the farthest point from the center point is a third reference distance (S1303). The third reference distance may be determined according to a height of a rack frame.

Next, the processor 140 may identify the identified cluster as a rack frame model (S1305).

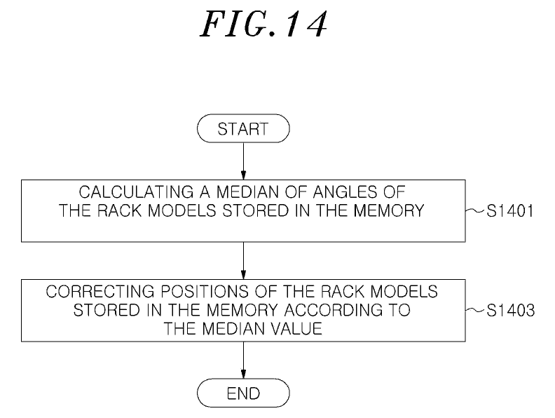

FIG. 14 is a flowchart illustrating a process of correcting the position of a rack model.

Hereinafter, the process of correcting the position of a rack model will be described with reference to FIG. 14. Some of the operations to be described below may be performed in a different order from the order described below or may be omitted. The process of FIG. 14 may be performed after the process of FIG. 11 is completed.

First, the processor 140 may calculate a median of the angles of the rack models stored in the memory 130 (S1401). In operation S1401, the processor 140 may detect the angle of each of the rack models stored in the memory 130, and identify the median value among the detected angles, thereby calculating the median of the angles of the rack models stored in the memory 130.

Next, the processor 140 may correct the positions of the rack models stored in the memory 130 according to the median value (S1403). In operation S1403, the processor 140 may correct the angle of each of the rack models stored in the memory 130 so that the angle becomes equal to the median value.

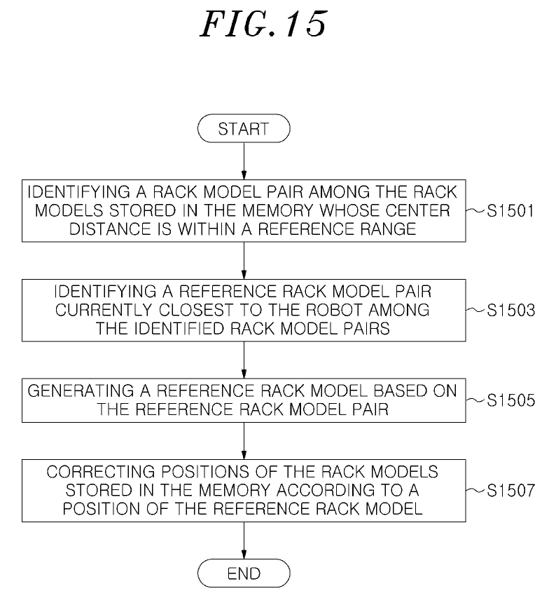

FIG. 15 is a flowchart illustrating another process of correcting the position of a rack model.

Hereinafter, a process of correcting the position of a rack model will be described with reference to FIG. 15. Some of the operations to be described below may be performed in a different order from the order described below or may be omitted. The process of FIG. 15 may be performed after the process of FIG. 11 is completed.

First, the processor 140 may identify a rack model pair among the rack models stored in the memory 130 whose center distance is within a reference range (S1501). The reference range may be set based on a width of a rack.

Next, the processor 140 may identify a rack model pair closest to the current robot among the identified rack model pairs (S1503).

Next, the processor 140 may generate a reference rack model based on the identified rack model pair (S1505). In operation S1505, the processor 140 may generate the reference rack model by referring to predefined rack layout information.

Next, the processor 140 may correct the positions of the rack models stored in the memory 130 according to the position information of the reference rack model (S1507). In operation S1507, the processor 140 may perform an operation of correcting the position of each of the rack models stored in the memory 130 to be the same as the position of the corresponding reference rack model.

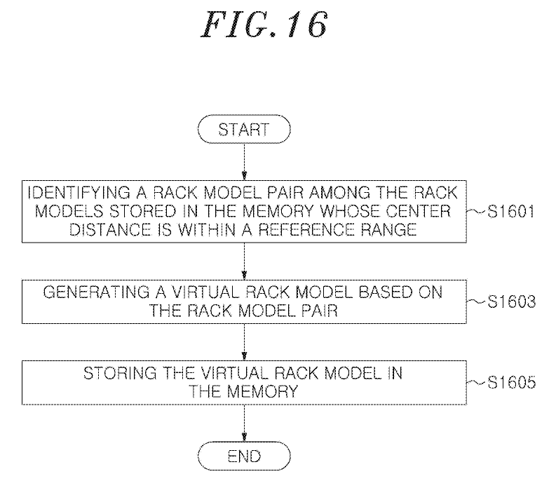

FIG. 16 is a flowchart illustrating a process of generating a virtual rack model.

Hereinafter, the process of generating a virtual rack model will be described with reference to FIG. 16. Some of the operations to be described below may be performed in a different order from the order described below or may be omitted. The process of FIG. 16 may be performed after the process of FIG. 11 is completed.

First, the processor 140 may identify a rack model pair among the rack models stored in the memory 130 whose center distance is within a reference range (S1601). The reference range may be set based on a width of a rack.

Next, the processor 140 may generate a virtual rack model based on the predefined rack model pair (S1603). In operation S1603, the processor 140 may generate a virtual rack model at a position separated to the left from the center point of the rack model located on the left side of the rack model pair by a first predetermined set distance. In operation S1603, the processor 140 may generate a virtual rack model at a position separated to the right from the center point of the rack model located on the right side of the rack model pair by the first set distance. In operation S1603, the processor 140 may generate a virtual rack model at positions separated upward and downward from the center point of the rack model located on the left side of the rack model pair by a second predetermined set distance. In operation S1603, the processor 140 may generate a virtual rack model at positions separated upward and downward from the center point of the rack model located on the right side of the rack model pair by the second set distance.

Next, the processor 140 may store the virtual rack model in the memory 130 (S1603).

As described above, the rack modeling apparatus and method according to the embodiments of the present disclosure may enable an autonomous robot to travel along a stable and optimized path within a logistics factory by modeling racks provided inside the logistics factory by using point cloud data collected through a robot equipped with a 2D LiDAR.

Although the present disclosure has been described with reference to the embodiments shown in the drawings, this is merely exemplary, and it will be understood by those skilled in the art that various modifications and equivalent other embodiments are possible therefrom.

Therefore, the true technical scope of protection of the present disclosure should be determined by the patent claims below.

What is claimed is:

1. A rack modeling apparatus, comprising:
a buffer;
a memory;
a communication module configured to communicate with a robot that is equipped with a 2D LiDAR and configured to move inside a logistics factory provided with a plurality of racks; and
a processor connected to the buffer, the memory, and the communication module,
wherein the processor is configured to repeatedly perform, at a predetermined set period, an operation including: acquiring point cloud data through the communication module; detecting a rack model based on the acquired point cloud data; storing the detected rack model in the buffer when the detected rack model is not stored in the buffer; assigning a preset score to the detected rack model when the detected rack model is already stored in the buffer; and storing, in the memory, a rack model having a score equal to or greater than a predetermined reference score among the rack models stored in the buffer.

2. The rack modeling apparatus of claim 1, wherein the processor is configured to:
detect a rack frame model from the point cloud data;
identify the rack frame model satisfying a predetermined rack size condition;
connect the identified rack frame model and a target for each of the detected rack frame models; and
identify, as the rack model, a rectangular structure having the rack frame models as corners.

3. The rack modeling apparatus of claim 2, wherein the rack size condition is satisfied when a distance from the target is equal to a first reference distance or a second reference distance, and
wherein the first reference distance is determined based on a predetermined rack width, and the second reference distance is determined based on a predetermined rack length.

4. The rack modeling apparatus of claim 2, wherein the processor is configured to:
generate a plurality of clusters by clustering points included in the point cloud data through a Euclidean clustering algorithm, and identify, as the rack frame model, the cluster satisfying a predetermined frame length condition from among the plurality of clusters.

5. The rack modeling apparatus of claim 4, wherein the frame length condition is satisfied when a distance between a center point and a farthest point from the center point is equal to a third reference distance, and
wherein the third reference distance is determined based on a predetermined rack frame height.

6. The rack modeling apparatus of claim 1, wherein the processor is configured to:
calculate a median of angles of the rack models stored in the memory; and
adjust positions of the rack models stored in the memory based on the median.

7. The rack modeling apparatus of claim 1, wherein the processor is configured to:
identify a rack model pair satisfying a predetermined model pair condition among the rack models stored in the memory;
identify a reference rack model pair among the identified rack model pairs, the reference rack model pair being a rack model pair closest to the robot;
generate a reference rack model based on the reference rack model pair; and
adjust a position of the rack model stored in the memory based on a position of the reference rack model.

8. The rack modeling apparatus of claim 7, wherein the model pair condition is that a center distance between rack models is within a predetermined reference range.

9. The rack modeling apparatus of claim 7, wherein the processor is configured to: generate the reference rack model based on predetermined rack layout information.

10. The rack modeling apparatus of claim 1, wherein the processor is configured to:
identify a rack model pair satisfying a predetermined model pair condition among the rack models stored in the memory;
generate a virtual rack model based on the rack model pair; and
store the virtual rack model in the memory.

11. The rack modeling apparatus of claim 10, wherein the processor is configured to:
generate a virtual rack model at a position separated to the left from a center point of a rack model located on a left side of the rack model pair by a first predetermined set distance;
generate a virtual rack model at a position separated to the right from a center point of a rack model located on a right side of the rack model pair by the first predetermined set distance;
generate a virtual rack model at positions separated upward and downward from the center point of the rack model located on the left side of the rack model pair by a second predetermined set distance; and
generate a virtual rack model at positions separated upward and downward from the center point of the rack model located on the right side of the rack model pair by the second predetermined set distance.

12. A rack modeling method, comprising:
acquiring, by a processor, point cloud data from a robot equipped with a 2D LiDAR and configured to move inside a logistics factory provided with a plurality of racks;
detecting, by the processor, a rack model based on the acquired point cloud data;
storing, by the processor, the detected rack model in a buffer when the detected rack model is not stored in the buffer;
assigning, by the processor, a predetermined score to the detected rack model when the detected rack model is already stored in the buffer;
storing, by the processor, a rack model in a memory from among the rack models stored in the buffer when the predetermined score is equal to or greater than a predetermined reference score; and
repeatedly performing, by the processor, at a predetermined set period, the acquiring, the detecting, the storing in the buffer, the assigning, and the storing in the memory.

13. The rack modeling method of claim 12, wherein the detecting the rack model includes:
detecting, by the processor, a rack frame model from the point cloud data;
detecting, by the processor, a rack frame model satisfying a predetermined rack size condition, and connecting the detected rack frame model and a target for each of the detected rack frame models; and
identifying, by the processor, a rectangular structure having the rack frame models as corners as the rack model.

14. The rack modeling method of claim 13, wherein the rack size condition is satisfied when a distance from the target is equal to a first reference distance or a second reference distance, and
wherein the first reference distance is determined based on a predetermined rack width, and the second reference distance is determined based on a predetermined rack length.

15. The rack modeling method of claim 13, wherein the detecting the rack model includes:
generating, by the processor, a plurality of clusters by clustering points included in the point cloud data through a Euclidean clustering algorithm; and
identifying, by the processor, a cluster satisfying a predetermined frame length condition among the plurality of clusters as a rack frame model.

16. The rack modeling method of claim 15, wherein the frame length condition comprises a distance between a center point and a farthest point from the center point matching a third reference distance, and the third reference distance is determined based on a predetermined rack frame height.

17. The rack modeling method of claim 12, further comprising, after the storing in the memory:
calculating, by the processor, a median of angles of the rack models stored in the memory; and
adjusting, by the processor, positions of the rack models stored in the memory according to the median value.

18. The rack modeling method of claim 12, further comprising:
identifying, by the processor, a rack model pair satisfying a predetermined model pair condition among the rack models stored in the memory;
identifying, by the processor, a reference rack model pair among the identified rack model pairs, the reference rack model pair being a rack model pair closest to the robot;
generating, by the processor, a reference rack model based on the reference rack model pair; and
adjusting, by the processor, a position of the rack model stored in the memory based on a position of the reference rack model.

19. The rack modeling method of claim 18, wherein the model pair condition is that a center distance between rack models is within a predetermined reference range.

20. The rack modeling method of claim 18, wherein the generating the reference rack model includes generating the reference rack model based on predetermined rack layout information.
